(19) United States
(12) Patent Application Publication
(10) Pub. No.: US 2016/0093957 A1
(43) Pub. Date: Mar. 31, 2016

(54) ARRAYED ANTENNA FOR MILLIMETER-WAVE AND TERAHERTZ APPLICATIONS

(71) Applicant: Lothar Benedikt Moeller, Middletown, NJ (US)

(72) Inventor: Lothar Benedikt Moeller, Middletown, NJ (US)

(21) Appl. No.: 14/496,312

(22) Filed: Sep. 25, 2014

(51) Int. Cl. H01Q 21/00; H01Q 9/16

(52) U.S. Cl. CPC H01Q 21/0006; H01Q 9/16

(57) ABSTRACT

We disclose an arrayed antenna for reception of electromagnetic radiation from a millimeter-wave or terahertz range. In an example embodiment, individual antenna cells in the arrayed antenna are configured for direct detection of the received electromagnetic radiation and are electrically connected in series or in parallel with one another in a manner that causes each of the antenna cells to positively contribute to the overall gain of the arrayed antenna. In some embodiments, individual antenna cells may have antenna structures that cause the arrayed antenna to have relatively low directivity. The total number of antenna cells in the arrayed antenna may be relatively large to cause the arrayed antenna to have a relatively high gain.

### CROSS-REFERENCE TO RELATED APPLICATIONS

The subject matter of this application is related to the subject matter of U.S. patent application Ser. No. 1______, by Lothar Moeller, attorney docket reference 816065-US-NP, filed on the same date as the present application, and entitled “ARRAYED ANTENNA FOR COHERENT DETECTION OF MILLIMETER-WAVE AND TERAHERTZ RADIATION,” which is incorporated herein by reference in its entirety.

### BACKGROUND

1. Field

The present disclosure relates to antennas and, more specifically but not exclusively, to arrayed antennas for millimeter-wave and terahertz applications.

2. Description of the Related Art

This section introduces aspects that may help facilitate a better understanding of the disclosure. Accordingly, the statements of this section are to be read in this light and are not to be understood as admissions about what is in the prior art or what is not in the prior art.

As used herein, the term “millimeter wave” refers to electromagnetic radiation from a range of frequencies between about 30 GHz and about 300 GHz. It has received this name because the corresponding wavelengths are between about 1 mm and about 10 mm. In some literature, this frequency range is also referred to as the EHF (Extremely High Frequency) band. The term “terahertz radiation” refers to electromagnetic radiation from a range of frequencies between about 300 GHz and about 3 THz. Because terahertz radiation includes wavelengths between about 1 mm and about 0.1 mm, it is also referred to as the sub-millimeter waves, especially often so in astronomy.

Practical applications of millimeter waves and terahertz radiation include but are not limited to imaging systems, security scanners, automotive sensors, wireless communications, defense usages, such as radar, and medical applications. The design of corresponding antennas is typically application specific, with integration, loss, gain, and directivity requirements varying significantly among different applications. Some of the applications require or may benefit from the use of a high-gain low-directivity antenna.

### SUMMARY OF SOME SPECIFIC EMBODIMENTS

Disclosed herein are various embodiments of an arrayed antenna for reception of electromagnetic radiation from a millimeter-wave or terahertz range. In an example embodiment, individual antenna cells in the arrayed antenna are configured for direct detection of the received electromagnetic radiation and are electrically connected in series or in parallel with one another in a manner that causes each of the antenna cells to positively contribute to the overall gain of the arrayed antenna. In some embodiments, individual antenna cells may have antenna structures that cause the arrayed antenna to have relatively low directivity. The total number of antenna cells in the arrayed antenna may be relatively large to cause the arrayed antenna to have a relatively high gain.

According to one embodiment, provided is an apparatus comprising a plurality of antenna cells electrically connected with one another and configured to generate an electrical output signal in response to electromagnetic radiation from a millimeter-wave or terahertz range received by the plurality of the antenna cells, wherein: each of the antenna cells is configured to perform direct detection of the electromagnetic radiation and comprises a respective rectifier circuit configured to generate a respective component of the electrical output signal; and the plurality of the antenna cells are electrically connected with one another to combine said respective components in a manner that causes the electrical output signal to have a greater power than a power of any of said respective components.

### BRIEF DESCRIPTION OF THE DRAWINGS

Other aspects, features, and benefits of various disclosed embodiments will become more fully apparent, by way of example, from the following detailed description and the accompanying drawings, in which:

FIG. 1 shows a block diagram of an antenna cell according to an embodiment of the disclosure;

FIG. 2 shows a circuit diagram of an antenna cell that can be used to implement the antenna cell of FIG. 1 according to an embodiment of the disclosure;

FIG. 3 shows a block diagram of an arrayed antenna that includes a plurality of the antenna cells shown in FIG. 2 according to an embodiment of the disclosure;

FIG. 4 shows a block diagram of an arrayed antenna that includes a plurality of the antenna cells shown in FIG. 2 according to an alternative embodiment of the disclosure;

FIG. 5 pictorially illustrates the use of the arrayed antenna of FIG. 3 or FIG. 4 in an aircraft according to an embodiment of the disclosure; and

FIG. 6 pictorially illustrates the use of the arrayed antenna of FIG. 3 or FIG. 4 in a mobile electronic device according to an embodiment of the disclosure.

### DETAILED DESCRIPTION

According to “IEEE Standard Definitions of Terms for Antennas,” an antenna is a “transmitting or receiving system that is designed to radiate or receive electromagnetic waves.” In principle, an antenna can be of any suitable shape and size. Representative types of antennas are (i) a wire antenna, e.g., a dipole or loop; (ii) an aperture antenna, e.g., a pyramidal horn; (iii) a reflector antenna, e.g., a parabolic dish antenna; (iv) a microstrip antenna, e.g., a patch antenna, etc. An arrayed antenna comprises a plurality of nominally identical antenna elements or cells (each having a respective antenna structure and the corresponding electrical circuitry) of any selected type that are spatially arranged in any desired (e.g., regular or irregular) pattern and electrically connected to cause the electrical signals generated by the individual antenna elements to be in a specified amplitude and/or phase relationship with one another. The latter characteristic causes an arrayed antenna to operate as a single antenna, generally having improved characteristics compared to the corresponding characteristics of an individual antenna element.

Embodiments disclosed herein are generally related to an arrayed antenna for reception of electromagnetic radiation. For illustration purposes and without undue limitations, embodiments of the disclosed arrayed antennas are described as comprising dipole-antenna structures. Based on the provided description and without undue experimentation, one of ordinary skill in the art will be able to make and use arrayed antennas that comprise other types of antenna structures.

FIG. 1 shows a block diagram of an antenna cell 100 according to an embodiment of the disclosure. In response to electromagnetic radiation received from a remote millimeter-wave or terahertz source, antenna cell 100 operates to generate an electrical output signal 132. The generated electrical output signal 132 can then be used for an intended purpose in a device or circuit coupled to antenna cell 100. In one embodiment, the generated electrical output signal 132 can be used in the form of an electrical current. In an alternative embodiment, the generated electrical output signal 132 can be used in the form of a voltage.

Antenna cell 100 is designed and configured to perform incoherent (e.g., direct) detection of the received electromagnetic radiation and operates to convert it into a corresponding electrical current or voltage. As known in the art, direct detection is not sensitive to the signal phase and causes only the signal power to be detected. While the received electromagnetic wave has a carrier frequency from the millimeter-wave or terahertz range, electrical output signal 132 generated by antenna cell 100 has a spectral content corresponding to the baseband of the waveform that was used to modulate the carrier frequency at the transmitter.

In an example embodiment, antenna cell 100 comprises an antenna structure 110, which may be of any suitable type, some of which are already mentioned above. Antenna structure 110 is electrically coupled to a baseband-converter circuit 120 as indicated in FIG. 1. Together, antenna structure 110 and baseband-converter circuit 120 are configured to perform direct detection of electromagnetic radiation impinging upon the antenna structure. A resulting electrical signal 122 generated by baseband-converter circuit 120 has a frequency content corresponding to the baseband of the millimeter-wave or terahertz signal received by antenna structure 110. In some embodiments, electrical signal 122 may be amplified in an optional amplifier (not explicitly shown in FIG. 1).

Direct detection of the received electromagnetic radiation performed in antenna cell 100 should be distinguished from and contrasted with heterodyne, intradyne, or homodyne detection, wherein a local-oscillator signal is used to down-convert the received signal from the millimeter-wave or terahertz range down to an intermediate-frequency range or the baseband. Embodiments of an arrayed antenna in which individual antenna cells are configured to use a local-oscillator signal are disclosed, e.g., in the above-referenced concurrently filed patent application (attorney docket reference 816065-US-NP) by Lothar Moeller. In contrast, antenna cell 100 shown in FIG. 1 does not use a local oscillator signal for the detection and down-conversion of the received millimeter-wave or terahertz signal.

Electrical signal 122 generated by baseband-converter circuit 120 is applied to a rectifier circuit 130, which transforms electrical signal 122 into electrical output signal 132. In one embodiment, rectifier circuit 130 may comprise a diode appropriately configured to rectify electrical signal 122 or an electrical signal generated based on or derived from electrical signal 122. In an alternative embodiment, any other suitable rectifier circuit may be used to implement rectifier circuit 130. In yet another alternative embodiment, rectifier circuit 130 may be replaced by an envelope-detector circuit.

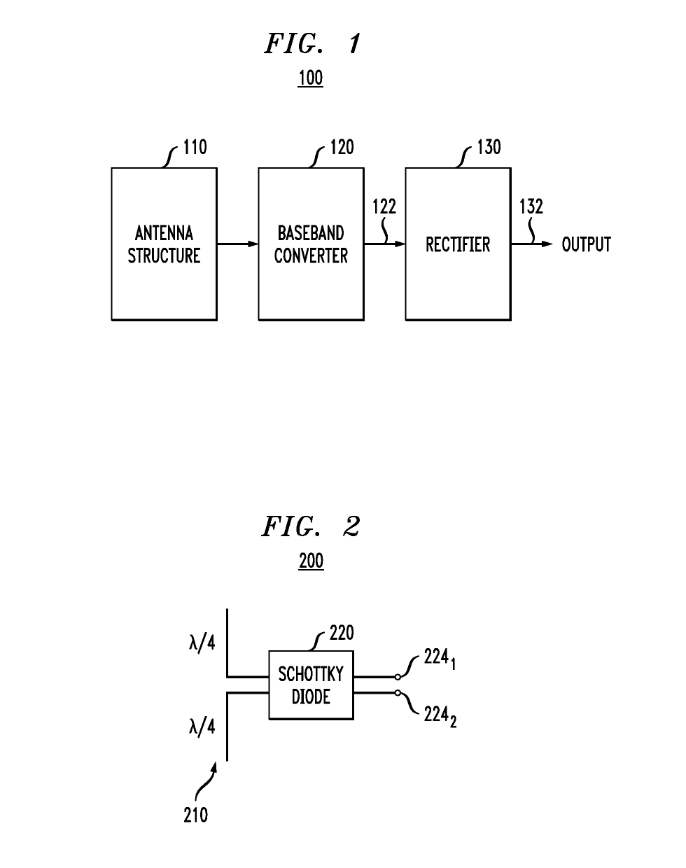

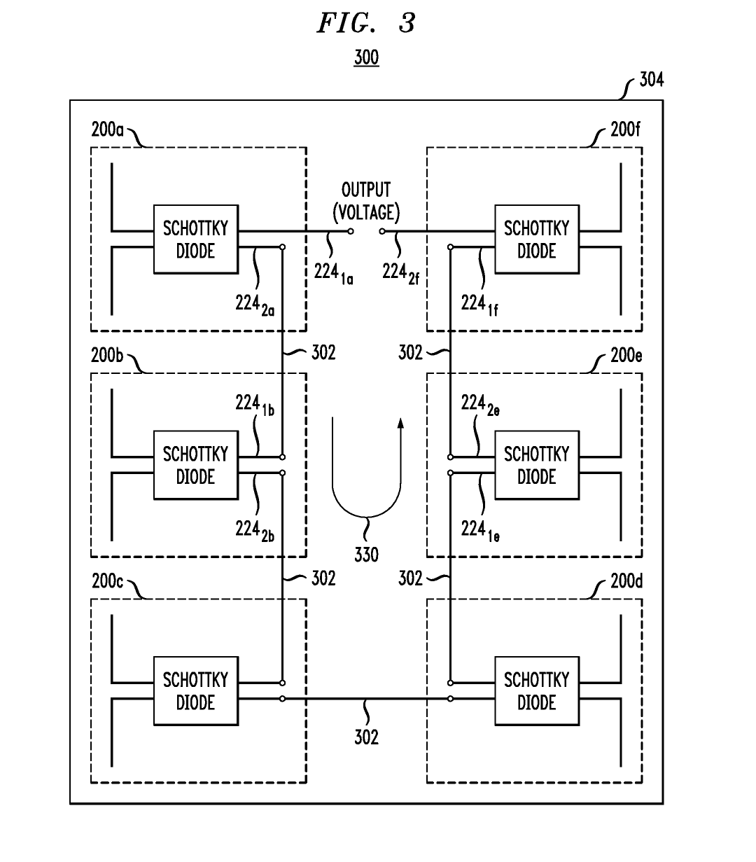

An example embodiment of antenna cell 100 is described in more detail below in reference to FIG. 2. Additional antenna structures and electrical circuits that may be used to implement antenna structure 110 and/or baseband-converter circuit 120, respectively, in various alternative embodiments of antenna cell 100 are disclosed, e.g., in U.S. Pat. No. 8,330,111 and U.S. Patent Application Publication Nos. 2014/0091376 and 2006/0081889, all of which are incorporated herein by reference in their entirety. Additional information that may be helpful in the implementation of antenna cell 100 can be found, e.g., in the review article by A. Rogalski and F. Sizov, entitled “Terahertz Detectors and Focal Plane Arrays,” published in Opto-Electronics Review, 2011, vol. 19, No. 3, pp. 346-404, which is incorporated herein by reference in its entirety.

FIG. 2 shows a circuit diagram of an antenna cell 200 that can be used to implement antenna cell 100 (FIG. 1) according to an embodiment of the disclosure.

In an example embodiment, antenna cell 200 comprises a dipole-antenna structure 210, which is illustratively shown as having two electrically conducting arms, each having a length of approximately λ/4, where λ is the wavelength of the electromagnetic radiation that antenna element 200 is designed to handle. Dipole-antenna structure 210 is coupled to a Schottky diode 220, which is configured to perform the functions of both baseband-converting and rectifying the electrical signal generated by the dipole-antenna structure. As such, Schottky diode 220 can be used, e.g., to replace both baseband-converter circuit 120 and rectifier circuit 130 in one embodiment of antenna cell 100 (FIG. 1). Together, dipole-antenna structure 210 and Schottky diode 220 are configured to perform direct detection of electromagnetic radiation impinging upon the dipole-antenna structure. The resulting electrical signal is outputted by Schottky diode 220 on output terminals 224₁ and 224₂ and has a frequency content corresponding to the baseband of the millimeter-wave or terahertz signal received by antenna structure 210.

FIG. 3 shows a block diagram of an arrayed antenna 300 that includes a plurality of antenna cells 200 (FIG. 2) according to an embodiment of the disclosure. Antenna 300 is illustratively shown in FIG. 3 as comprising six antenna cells 200 (labeled 200a-200f) arranged in a two-dimensional rectangular array and serially electrically connected using electrical conductors 302. In an alternative embodiment, antenna 300 may have more or fewer than six antenna cells 200. Other spatial arrangements and electrical connections of antenna cells 200 are also contemplated. In response to electromagnetic radiation received from a remote millimeter-wave or terahertz source, antenna 300 generates an electrical output signal at output terminals 224₁ₐ and 224_{2f}. The generated electrical output signal can then be used for an intended purpose in a device or circuit coupled to output terminals 224₁ₐ and 224_{2f}.

In one embodiment, each antenna cell 200 in antenna 300 has a linear size that is about one half of wavelength λ of the electromagnetic radiation that antenna 300 is designed to receive. A distance between (e.g., the geometric centers of) neighboring antenna cells 200 in antenna 300 may be about one wavelength λ. Distances between neighboring columns and rows of antenna cells 200 in the spatial array of antenna 300 may or may not be the same.

In some embodiments, a linear size (e.g., a side length or a distance between two corner antenna cells, such as 200a and 200d) of antenna 300 is much (e.g., by a factor of 10) smaller than a “symbol length” in the received electromagnetic radiation. The term “symbol length” applies to embodiments in which antenna 300 is configured to receive electromagnetic radiation having a carrier frequency that is amplitude-modulated with data using regular time intervals referred to as symbol periods. The symbol length can be calculated by multiplying the duration of a symbol period (e.g., in seconds) by the speed of light. Depending on the particular application, a linear size of antenna 300 may vary from approximately 1 mm to several meters. In some embodiments, the total area of antenna 300 may be much larger (e.g., by a factor of about 100 or more) than λ² due to a relatively large number of antenna cells used therein.

In some embodiments, antenna 300 may have relatively low directivity, e.g., due to the relatively low directivity of individual antenna cells 200. The gain of antenna 300 may be approximately proportional to the effective area occupied by antenna cells 200 therein. For comparison, the effective area of a conventional antenna changes as ˜λ².

Antenna cells 200 in antenna 300 are serially connected to one another along an electrical path 330 that alternately connects output terminals 224₁ and 224₂ of neighboring antenna cells 200 as indicated in FIG. 3. In one embodiment, electrical path 330 may zigzag through the spatial array of antenna cells 200 in antenna 300 such that, for each antenna cell 200, among other antenna cells 200 that are directly spatially adjacent to that antenna cell in the spatial array there is: (i) at least one antenna cell that is an immediate next antenna cell in the electrical path, and (ii) at least one antenna cell that is separated from the antenna cell in the electrical path by one or more additional antenna cells. For example, for antenna cell 200a, some of the directly spatially adjacent antenna cells in the spatial array may be antenna cells 200b and 200f. As used herein, the term “directly spatially adjacent” refers to the fact that a straight line that connects antenna cell 200a to any one of antenna cells 200b and 200f does not pass through any other antenna cells. Among antenna cells 200b and 200f, antenna cell 200b is an immediate next antenna element with respect to antenna cell 200a in electrical path 330 because there are no other antenna cells in electrical path 330 between antenna cell 200a and antenna cell 200b. In addition, among antenna cells 200b and 200f, antenna cell 200f is separated from antenna cell 200a in electrical path 330 by other antenna cells, e.g., 200b-200e.

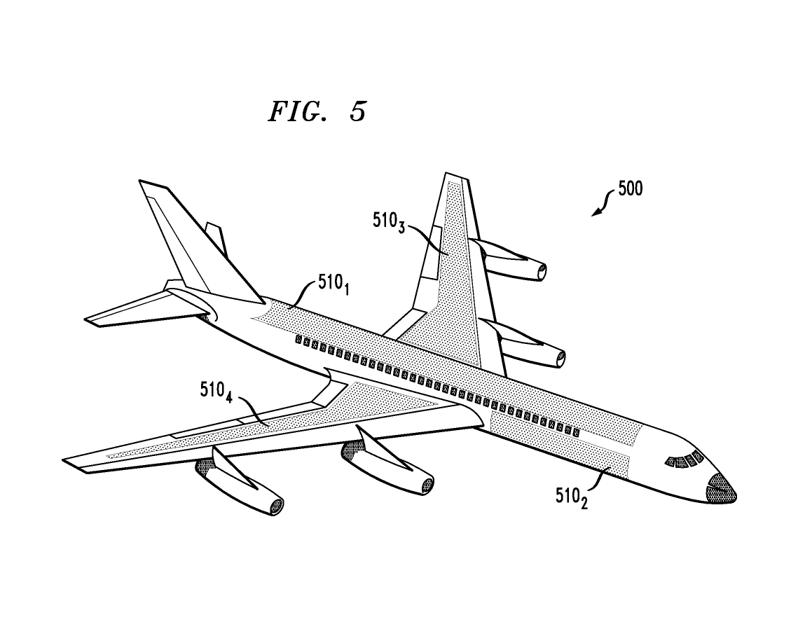

In some embodiments, antenna cells 200a-200f may be fabricated on a common substrate 304 and be a part of a corresponding single integrated circuit, die, or chip. In embodiments having a relatively large size of antenna cells 200, the antenna cells can be mounted on a common base (e.g., circuit board or support structure) 304. In some embodiments, base 304 may be non-planar, e.g., as further described below in reference to FIG. 5.

In operation, the electrical connections between antenna cells 200 in electrical path 330 cause the electrical voltages generated by the individual antenna cells 200 to be summed constructively. Due to this property, antenna 300 is capable of producing a relatively strong baseband output signal at output terminals 224₁ₐ and 224_{2f}. Advantageously, the gain of antenna 300 can be significantly larger than the gain of an individual antenna cell 200 therein.

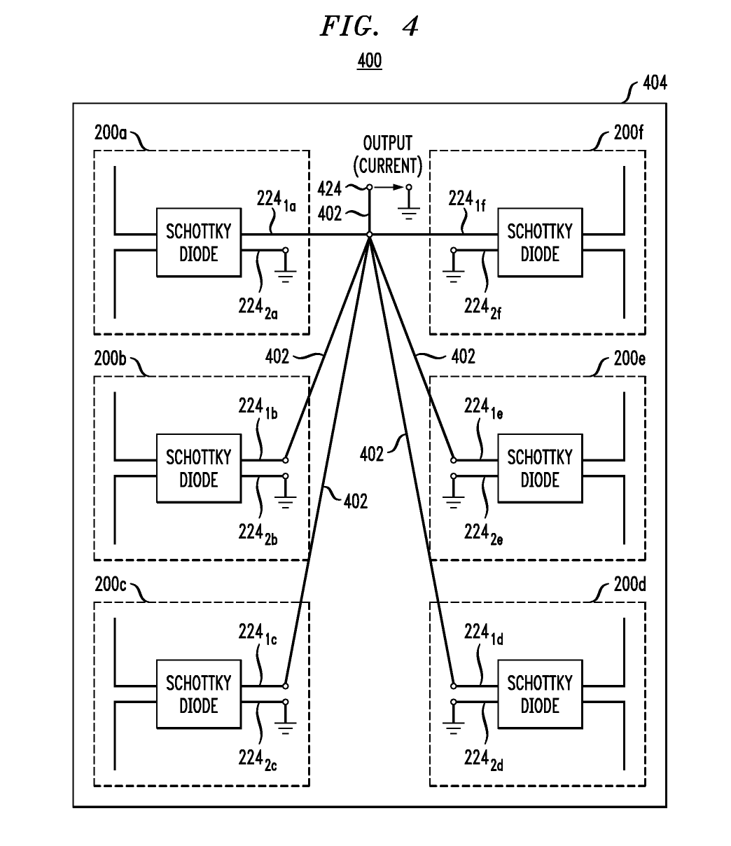

FIG. 4 shows a block diagram of an arrayed antenna 400 that includes a plurality of antenna cells 200 (FIG. 2) according to another embodiment of the disclosure. Antenna 400 is illustratively shown in FIG. 4 as comprising six antenna cells 200 (labeled 200a-200f) arranged in a two-dimensional rectangular array and electrically connected in parallel using electrical conductors 402. In an alternative embodiment, antenna 400 may have more or fewer than six antenna cells 200.

In an example embodiment, antenna 400 may be generally similar to antenna 300 (FIG. 3), except that antenna cells 200a-200f in antenna 400 are electrically connected in parallel. For example, output terminals 224₂ₐ-224_{2f} may all be electrically connected to a common ground, and output terminals 224₁ₐ-224_{1f} may all be electrically connected to a common output terminal 424. In response to electromagnetic radiation received from a remote millimeter-wave or terahertz source, antenna 400 generates an electrical current at output terminal 424 as indicated in FIG. 4. In some embodiments, antenna cells 200a-200f may be fabricated on a common substrate or base 404, which may be similar to common substrate or base 304 (FIG. 3).

In operation, the electrical connections between antenna cells 200 in antenna 400 cause the electrical currents generated by the individual antenna cells 200 to be summed constructively. Due to this property, antenna 400 is capable of producing a relatively strong baseband output signal at output terminal 424. Advantageously, the gain of antenna 400 can be significantly larger than the gain of an individual antenna cell 200 therein.

FIG. 5 pictorially illustrates the use of antenna 300 (FIG. 3) or 400 (FIG. 4) in an aircraft 500 according to an embodiment of the disclosure. More specifically, aircraft 500 has four antennas 510, which are labeled 510₁-510₄, respectively. In an example embodiment, an individual antenna 510 may be implemented using an embodiment of antenna 300 or 400. Antennas 510₁ and 510₂ are positioned along the fuselage portions of aircraft 500 and have corresponding surface-conforming topologies. Antennas 510₃ and 510₄ are similarly positioned along the wing portions of aircraft 500 and also have corresponding surface-conforming topologies. As a result, bases 304 or 404 of antennas 510 have non-planar shapes, each of which conforms to the corresponding geometric shape of the underlying fuselage/wing portion. In one embodiment, antennas 510₁-510₄ may be configured for radar reception, e.g., to aid navigation and/or collision-avoidance systems of aircraft 500. In another embodiment, antennas 510₁-510₄ may be configured for wireless communications with stations external to aircraft 500.

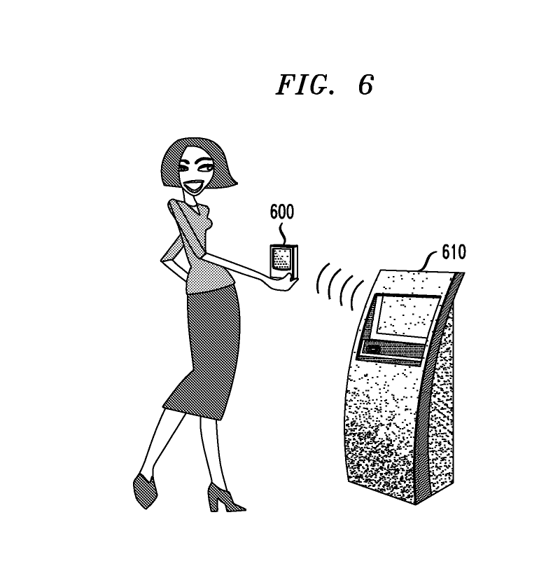

FIG. 6 pictorially illustrates the use of antenna 300 (FIG. 3) or 400 (FIG. 4) in a mobile (e.g., hand-held) electronic device 600 according to an embodiment of the disclosure. Antenna 300 or 400 (not explicitly shown in FIG. 6) is part of device 600 and is used to enable the device to perform high-speed downloads from a stationary transmitter (kiosk) 610. Kiosk 610 may be connected to a fiber-optic network and/or have an embedded storage as a source of the content that the user of device 600 might want to obtain. Hence, the user may configure device 600 to establish a high-speed downlink with kiosk 610 using antenna 300 or 400 of device 600, while downlink-setup and all uplink communications are handled through a legacy wireless channel, such as Bluetooth. After the high-speed downlink between device 600 and kiosk 610 is established, it can be used to download a relatively large volume of data in a relatively short period of time.

In an example embodiment, a high-speed downlink between device 600 and kiosk 610 established using millimeter-wave or terahertz signals can support data rates on the order of about 10 Gbit/s or higher, which are not available over legacy wireless links. However, the high-speed downlink may be operative only at relatively short distances, e.g., on the order of one meter. Nevertheless, the relatively low directivity of antenna 300 or 400 advantageously enables the user of device 600 not to be concerned with any specific orientation of her device with respect to kiosk 610, while the relatively high gain of antenna 300 or 400 ensures high reliability of the high-speed downlink.

According to an example embodiment disclosed above in reference to FIGS. 1-6, provided is an apparatus comprising a plurality of antenna cells (e.g., 200a-200f; FIGS. 3-4) electrically connected with one another and configured to generate an electrical output signal in response to electromagnetic radiation from a millimeter-wave or terahertz range received by the plurality of the antenna cells, wherein: each of the antenna cells is configured to perform direct detection of the electromagnetic radiation and comprises a respective rectifier circuit (e.g., 130, FIG. 1; 220, FIG. 2) configured to generate a respective component of the electrical output signal; and the plurality of the antenna cells are electrically connected with one another to combine said respective components in a manner that causes the electrical output signal to have a greater amplitude than an amplitude of any of said respective components.

In some embodiments of the above apparatus, the plurality of the antenna cells are connected in parallel between a first common electrical terminal (e.g., ground, FIG. 4) and a second common electrical terminal (e.g., 424, FIG. 4); each of said respective components is a respective electrical-current component; and the respective rectifier circuits are configured to cause said respective electrical-current components to have a same polarity to add constructively at one of the first and second common electrical terminals.

In some embodiments of any of the above apparatus, the plurality of the antenna cells are connected in series along an electrical path (e.g., 330, FIG. 3); each of said respective components is a respective voltage component; and the respective rectifier circuits are configured to cause said respective voltage components to have a same polarity to add constructively along the electrical path.

In some embodiments of any of the above apparatus, the plurality of the antenna cells are arranged in a spatial array on a surface of a base (e.g., 304, FIG. 3; 404, FIG. 4); and for each of the antenna cells (e.g., 200b, FIG. 3), the spatial array has a set of two or more other antenna cells (e.g., 200a, 200c-200f, FIG. 3) that are directly spatially adjacent to the antenna cell in the spatial array, said set including: at least one antenna cell (e.g., 200a, FIG. 3) that is an immediate next antenna cell in the electrical path; and at least one antenna cell (e.g., 200e, FIG. 3) that is separated from the antenna cell in the electrical path by one or more antenna cells.

In some embodiments of any of the above apparatus, the plurality of the antenna cells are arranged in a spatial array on a surface of a base (e.g., 304, FIG. 3; 404, FIG. 4).

In some embodiments of any of the above apparatus, the surface is non-planar (e.g., as in FIG. 5).

In some embodiments of any of the above apparatus, the base is a part of a wing or a fuselage of an aircraft (e.g., as in FIG. 5).

In some embodiments of any of the above apparatus, the apparatus is configured to generate the electrical output signal in response to the electromagnetic radiation having a carrier wavelength; and the plurality of the antenna cells are arranged in a spatial array in which directly spatially adjacent antenna cells are spaced by a distance that is approximately equal to the carrier wavelength.

In some embodiments of any of the above apparatus, each of the plurality of the antenna cells has a linear size that is approximately one half of the carrier wavelength.

In some embodiments of any of the above apparatus, the apparatus is configured to generate the electrical output signal in response to the electromagnetic radiation that is amplitude-modulated with data over a sequence of symbol periods; and the spatial array has a linear size that is smaller than a symbol length in the amplitude-modulated electromagnetic radiation.

In some embodiments of any of the above apparatus, the plurality of antenna cells includes at least 3 antenna cells.

In some embodiments of any of the above apparatus, the plurality of antenna cells includes at least 10 antenna cells.

In some embodiments of any of the above apparatus, the plurality of antenna cells includes at least 100 antenna cells.

In some embodiments of any of the above apparatus, the plurality of the antenna cells have been fabricated on a common substrate and are parts of a single integrated-circuit die.

In some embodiments of any of the above apparatus, each of the plurality of antenna cells is not configured to use a local oscillator signal for generation of the electrical output signal.

In some embodiments of any of the above apparatus, each of the plurality of the antenna cells comprises: a respective antenna structure (e.g. 110, FIG. 1; 210, FIG. 2); and a respective baseband-converter circuit (e.g., 120, FIG. 1; 220, FIG. 2) coupled to the respective antenna structure, wherein the respective antenna structure and the respective baseband-converter circuit are configured to perform the direct detection of the electromagnetic radiation.

In some embodiments of any of the above apparatus, the respective antenna structure comprises a respective pair of electrically conductive arms arranged in a linear-dipole configuration (e.g., as in 210, FIG. 2).

In some embodiments of any of the above apparatus, each of the plurality of antenna elements comprises a respective Schottky diode (e.g., 220, FIG. 2) configured to perform circuit functions of both the respective baseband-converter circuit and the respective rectifier circuit.

In some embodiments of any of the above apparatus, the apparatus is a cell phone (e.g., 600, FIG. 6).

While this disclosure includes references to illustrative embodiments, this specification is not intended to be construed in a limiting sense.

For example, some embodiments may also be used with microwave radiation, e.g., having frequencies between about 1 GHz and about 30 GHz.

Antenna structures in different antenna cells of the arrayed antenna may have the same orientation or different orientations.

Various modifications of the described embodiments, as well as other embodiments within the scope of the disclosure, which are apparent to persons skilled in the art to which the disclosure pertains are deemed to lie within the principle and scope of the disclosure, e.g., as expressed in the following claims.

Some embodiments may be implemented as circuit-based processes, including possible implementation on a single integrated circuit.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this disclosure may be made by those skilled in the art without departing from the scope of the disclosure, e.g., as expressed in the following claims.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like, represent various processes which may be substantially represented in computer readable medium and so executed by a computer or processor, whether or not such computer or processor is explicitly shown.

What is claimed is:

1. An apparatus comprising a plurality of antenna cells electrically connected with one another and configured to generate an electrical output signal in response to electromagnetic radiation from a millimeter-wave or terahertz range received by the plurality of the antenna cells, wherein:
each of the antenna cells is configured to perform direct detection of the electromagnetic radiation and comprises a respective rectifier circuit configured to generate a respective component of the electrical output signal; and
the plurality of the antenna cells are electrically connected with one another to combine said respective components in a manner that causes the electrical output signal to have a greater power than a power of any of said respective components.

2. The apparatus of claim 1, wherein:
the plurality of the antenna cells are connected in parallel between a first common electrical terminal and a second common electrical terminal;
each of said respective components is a respective electrical-current component; and
the respective rectifier circuits are configured to cause said respective electrical-current components to have a same polarity to add constructively at one of the first and second common electrical terminals.

3. The apparatus of claim 1, wherein:
the plurality of the antenna cells are connected in series along an electrical path;
each of said respective components is a respective voltage component; and
the respective rectifier circuits are configured to cause said respective voltage components to have a same polarity to add constructively along the electrical path.

4. The apparatus of claim 3, wherein:
the plurality of the antenna cells are arranged in a spatial array on a surface of a base; and
for each of the antenna cells, the spatial array has a set of two or more other antenna cells that are directly spatially adjacent to the antenna cell in the spatial array, said set including:
at least one antenna cell that is an immediate next antenna cell in the electrical path; and
at least one antenna cell that is separated from the antenna cell in the electrical path by one or more antenna cells.

5. The apparatus of claim 1,
wherein the plurality of the antenna cells are arranged in a spatial array on a surface of a base; and
wherein the surface is non-planar.

6. The apparatus of claim 1,
wherein the plurality of the antenna cells are arranged in a spatial array on a surface of a base; and
wherein the base is a part of a wing or a fuselage of an aircraft.

7. The apparatus of claim 1,
wherein the apparatus is configured to generate the electrical output signal in response to the electromagnetic radiation having a carrier wavelength; and
wherein the plurality of the antenna cells are arranged in a spatial array in which directly spatially adjacent antenna cells are spaced by a distance that is approximately equal to the carrier wavelength.

8. The apparatus of claim 7, wherein each of the plurality of the antenna cells has a linear size that is approximately one half of the carrier wavelength.

9. The apparatus of claim 7,
wherein the apparatus is configured to generate the electrical output signal in response to the electromagnetic radiation that is amplitude-modulated with data over a sequence of symbol periods; and
wherein the spatial array has a linear size that is smaller than a symbol length in the amplitude-modulated electromagnetic radiation.

10. The apparatus of claim 1, wherein the plurality of antenna cells includes at least 3 antenna cells.

11. The apparatus of claim 10, wherein the plurality of antenna cells includes at least 10 antenna cells.

12. The apparatus of claim 10, wherein the plurality of antenna cells includes at least 100 antenna cells.

13. The apparatus of claim 1, wherein the plurality of the antenna cells have been fabricated on a common substrate and are parts of a single integrated-circuit die.

14. The apparatus of claim 1, wherein each of the plurality of antenna cells is not configured to use a local oscillator signal for generation of the electrical output signal.

15. The apparatus of claim 1, wherein each of the plurality of the antenna cells comprises:
a respective antenna structure; and
a respective baseband-converter circuit coupled to the respective antenna structure, wherein the respective antenna structure and the respective baseband-converter circuit are configured to perform the direct detection of the electromagnetic radiation.

16. The apparatus of claim 15, wherein the respective antenna structure comprises a respective pair of electrically conductive arms arranged in a linear-dipole configuration.

17. The apparatus of claim 15, wherein each of the plurality of antenna elements comprises a respective Schottky diode configured to perform circuit functions of both the respective baseband-converter circuit and the respective rectifier circuit.

18. The apparatus of claim 1, wherein the apparatus is a cell phone.
